(19) United States
(12) Patent Application Publication
(10) Pub. No.: US 2018/0032931 A1
(43) Pub. Date: Feb. 1, 2018

(54) RESOURCE MONITORING METHOD AND SYSTEM

(71) Applicant: KONINKLIJKE PHILIPS N.V., EINDHOVEN (NL)

(72) Inventors: KIRAN HAMILTON J. DELLIMORE, EINDHOVEN (NL); KARTHIK SUBBARAMAN, MUMBAI (IN); FLORA KAAI, NAIROBI (KE); ANIL SHIVRAM RAIKER, BANGALORE (IN)

(21) Appl. No.: 15/661,095

(22) Filed: Jul. 27, 2017

(30) Foreign Application Priority Data
Jul. 27, 2016 (EP) 16181510

(51) Int. Cl. G06Q 10/06; G06Q 50/06; G06F 19/00

(52) U.S. Cl. CPC G06Q 10/0639; G06F 19/327; G06Q 10/063114; G06Q 50/06; G06Q 50/22

(57) ABSTRACT

The invention provides a resource monitoring method for a facility in a resource constrained environment, the method being adapted to provide a facility rating value based on measures of both human resource consumption and equipment or infrastructure resource consumption over a period of time. A first use value is obtained, representative of a measure of human resource used over a period of time. A second use value is obtained, representative of a measure of resource consumption of equipment and infrastructure (i.e. non-human resource use) over the same period of time. The facility rating value is generated based on the first use value and the second use value.

### FIELD OF THE INVENTION

This invention relates to the field of resource constrained environments, and in particular to the monitoring of resources of facilities in such resource constrained environments.

### BACKGROUND OF THE INVENTION

For facilities in resource constrained environments, there is typically limited or minimal access to energy, water or other resources, such that resources are a key limiting factor in the environment's ability to provide quality goods and services. It is known that facilities in resource constrained environments also face the issue of unreliable resource supplies, which may affect the quality of goods and services that the facility is capable of providing.

Known facilities in resource constrained environments include healthcare or clinical facilities, e.g. hospitals and health clinics. Such facilities are particularly susceptible and sensitive to limited resources. By way of example, power outages or lack of resources may lead patients to forego care, or to be referred to a more distant facility. This creates a reduction in healthcare availability or efficiency for an individual in the surrounding area and limited service readiness for the health facility.

Other known facilities in resource constrained environments could include educational facilities, e.g. schools and colleges, recreational facilities, or even manufacturing facilities. Lack of resource reduces the potential efficiency or capability of these facilities in producing their good or services.

Furthermore, world-wide population growth has led to an ever-increasing demand for the goods and services produced by facilities based in resource constrained environments, which leads to a corresponding increase in resource demand. As the availability of resources provided by resource constrained environments have finite limits, it is evident that, without intervention, the delivery of high quality goods and services will be increasingly difficult or even unsustainable in the long run.

Accordingly, there has been an increasing desire to optimize and manage the resource requirements for facilities in such resource constrained environments, in order to more efficiently and consistently deliver high quality and optimal goods and services.

### SUMMARY OF THE INVENTION

The invention is defined by the claims.

There is proposed an resource monitoring method for a facility in a resource constrained environment, the method comprising: obtaining a first use value representative of an expenditure of human resource associated with the facility over a period of time; obtaining a second use value representative of a power consumption of equipment and infrastructure associated with the facility over the same period of time; and generating a facility rating value by performing at least one operation using the first use value and the second use value as operands.

In other words, there is herein presented the concept of a resource monitoring method which generates a facility rating value representative of both human resource expenditure (e.g. manpower) and equipment/infrastructure resource usage during a predetermined period of time.

By providing such a facility rating value, an ease of monitoring resource usage and resource efficiency is improved. In other words, the method provides an intuitive and easily comprehensible rating value for a facility in a resource-restricted environment, as well as providing a quantitative and objective rating for the assessment of such facilities. This permits an individual to quickly and accurately assess the resource consumption of the facility in the resource-constrained environment and determine if a suitable or appropriate resource management scheme has been attained. In turn, this allows for an improved ease in determining progress and/or the effects of a resource management scheme.

In carrying out the method, a first use value and a second use value are obtained. The first use value is associated with the human resource expenditure within the predetermined period of time; and the second use value is associated with the equipment/infrastructure (i.e. non-human) resource expenditure during the predetermined period of time.

The proposed method is for a facility in a resource constrained environment, being an environment in which capabilities of that environment are limited or sensitive to resources. Such resources may include, for example, staffing resources, manpower, energy resources (e.g. available electricity or alternative energy supplies) and so on.

In some examples, the human resource expenditure may be representative of a caloric energy expenditure of staff in the facility during the predetermined period of time. In other examples, the human resource expenditure is simply representative of a number of available man-hours or labour capabilities in the period of time.

In some examples, the non-human or equipment/infrastructure resource expenditure may be representative of an amount of energy consumed by equipment or the facilities' infrastructure (e.g. lighting, heating or security) demands during the predetermined period of time. This may include at least an amount of electrical energy used in the facility, but may also or alternatively include other energy sources such as gas energy (which may be used to operate certain equipment), coal energy (e.g. for heating), oil energy (e.g. kerosene lamps) and so on. In some other or further embodiments, the equipment/infrastructure resource expenditure is representative of an expenditure or consumption of water, paper, supplies and so on.

The predetermined period of time (i.e. the period of time) may, by way of example only, be a 24-hour period, an 8-hour period (e.g. a working day), a 1-hour period, an overnight period, a period spanning a week or month, a period from sunrise to sunset and vice versa, and so on. In some preferable embodiments, the predetermined period of time is a 24-hour period, as this may be most representative of the facility rating requirements (as energy demands are likely to fluctuate throughout the day, but unlikely to significantly vary from day-to-day).

In some embodiments, in order to generate the facility rating value, an operation is performed using at least the first use value and the second use value as operands. It is evident that in some conceivable embodiments, more than one facility rating value is generated based on at least the human resource expenditure and the non-human resource expenditure using, for example, different operations.

By way of example, the generating the facility rating value may comprise at least one of the following: generating a composite facility rating value representative of a sum of the first use value and the second use value; and generating a ratio facility rating value representative of a ratio of the first use value to the second use value or vice versa. In other examples, there may be provided a product facility rating value representative of a product of the first use value and the second use value. Thus the facility rating value may be a composite facility rating value, a ratio facility rating value or a product overall value. It will therefore be apparent that the generation of the facility rating value may include generating more than one, and optionally different, facility rating values.

By using both the human and non-human resource expenditure in calculating the facility rating value, a rating for the facility may refer to additional and non-traditional resource measures in establishing a facility's capabilities in a resource-constrained environment.

The resource monitoring method may further comprise comparing the facility rating value to a reference rating value.

The reference rating value may be obtained, for example, from similar facilities in similar resource constrained environments known to have a suitable resource management system. In this way, the relative resource usage or relative resource efficiency may be readily assessed. In other scenarios, a desired facility rating value may be identified (e.g. through a known algorithm or based on historical data) and the generated facility rating value may be compared to it. In some other embodiments, a historical facility rating value may be obtained (e.g. the previously generated facility rating value) and compared to the presently generated facility rating value.

In further such embodiments, the resource monitoring method comprises performing at least one of: determining, based on the comparison, whether the facility has sufficient resources for a predetermined scenario; and determining, based on the comparison, whether to adjust at least one of staffing, equipment use or infrastructure use associated with the facility.

The predetermined scenario may be definable by the reference rating value, such that the reference rating value is representative of a particular or desired scenario. In this way, a determination of whether a current resource management system is able to meet a desired or probable future scenario may be readily determined.

Adjustment of equipment use may include alternative deployment (e.g. position of or availability of) equipment used to perform a task, applying resource or energy conservation practices to equipment/infrastructure, adjusting resource or energy generating equipment used to generate resources for use by other equipment and so on.

Adjustment of staffing may include increasing or decreasing the number of employed staff, reassigning staff to more efficient roles, changing staffing hours and the like.

In at least one particular embodiment, there is proposed a resource monitoring method of any preceding claim in which the facility rating value comprises: a composite facility rating value representative of a sum of the first use value and the second use value; and a ratio facility rating value representative of a ratio of the first use value to the second use value or vice versa, and wherein the method comprises: comparing the composite facility rating value to a composite reference value; comparing the ratio facility rating value to a ratio reference rating value; and determining, based on the two comparisons, whether the resource constrained environment has appropriate resources for a predetermined scenario.

Put another way, there is proposed an embodiment in which two facility rating values are determined, a composite facility rating value (formed by summing the first and second energy values) and a ratio facility rating value (formed by dividing the first energy value by the second energy value or vice versa).

The composite facility rating value (i.e. associated with the resource constrained environment) may be compared to a composite reference rating value. It has been herein recognised that both human and non-human resource resources ought to be taken into account when determining the efficiency of a resource constrained environment, a factor which the composite facility rating value readily identifies.

Similarly, the ratio overall value may be compared to a ratio reference rating value. It is herein recognised that there is a relationship between the amount of equipment/infrastructure resource expenditure and an amount of human resource required (e.g. to optimally use such available resource expenditure). Generation and comparison of a ratio facility rating value may allow a user to determine whether efficient use is being made of the equipment/infrastructure or whether adjustments need to be made to human resources (i.e. increased or decreased staffing).

In an embodiment, obtaining the first use value comprises: segmenting staff, associated with the resource-constrained environment and available during the period of time, into at least two categories; obtaining, for each category, an average expenditure value representative of the average expenditure of human resource over the period of time for the respective category; generating, for each category, a human resource addend, the generating comprising multiplying a number of staff in the respective category by the average expenditure value associated with the respective category; summing the human resource addends to obtain the first use value.

In other words, the method may comprise, for each of at least two categories, determining how many members of staff (of the resource constrained environment) fit within that category. The method may further comprise determining, for each of the at least two categories, an average expenditure of human resource over the period of time.

In other embodiments, the obtaining the first use value may comprise: determining a number of times a predetermined task, associated with the facility, is performed during the period of time; obtaining an average time value representative of the average period of time required to perform the predetermined task; generating the first use value based on the product of the number of times the task is to be performed and the average time value.

Put another way, the method may include determining a facility rating expenditure representative of the energy expended by staff in performing a particular task. The particular task may be one which most closely represents the primary or most significant goods or services provided by the facility.

It has been recognised that, for some facilities, it may be more relevant to monitor or optimize only a single task, so as to emphasise improvement or development of the single task.

Further such embodiments may comprise obtaining an average energy value representing the average energy expended in performing the predetermined task, wherein the generating of the first use value is further based on the average energy value.

In this way, the energy associated with performing a task may be taken into account. This may provide a more accurate or appropriate representation of the human resource expended in performing the task during the period of time.

The average energy value may be an average energy value per unit of time (e.g. per second), in order to achieve a more accurate representation of the total human resource expended over the predetermined period of time.

Optionally, obtaining the second use value comprises: segmenting the equipment and infrastructure associated with the resource constrained environment into at least two categories; obtaining, for each category, an average resource consumption value representative of the average resource consumption over the period of time in the respective category; generating, for each category, a resource consumption addend, the generating comprising multiplying a number of equipment and infrastructure in each category by the average resource consumption value associated with the respective category; summing the resource consumption addends to obtain the second use value.

In other words, the method may comprise assigning each piece of equipment or each infrastructure element to a category, wherein there are at least two categories. For each category, a number of pieces of equipment or infrastructure elements may be multiplied by an average resource consumption associated with that category to obtain a resource consumption addend. In other words, for each category, a total resource consumption value of that category is obtained. The total resource consumption values are summed or added together so as to obtain the second use value.

According to a preferable concept of the inventive concept, there is provided a clinical environment resource monitoring method comprising the resource monitoring method as previously described, wherein: the first use value is representative of the human resource expenditure of at least the clinical staff of a clinical facility over a period of time; and the second use value is representative of the resource expenditure of at least medical equipment of the clinical facility over the same period of time.

In other words, in preferable embodiments, the resource monitoring method is for a clinical facility, such as a hospital, clinic, doctor's surgery, pharmacies, hospice, care-facility and so on. Such facilities are particularly susceptible to changes in resources, and it has been herein recognised that a resource monitoring system that monitors both human and non-human resources provides improved efficiency and delivery of healthcare.

According to another aspect of the inventive concept, there is provided a resource monitoring system for a resource constrained environment, the system comprising: an obtaining unit adapted to obtain a first use value representative of an expenditure of human resource over a period of time and obtain a second use value representative of a resource consumption of equipment and infrastructure of the resource constrained environment over the same period of time; and a calculation unit adapted to generate an facility rating value by performing an operation using the first use value and the second use value as operands.

Such a system may further comprise a comparison unit adapted to compare the facility rating value to a reference rating value.

The resource monitoring system optionally further comprises a determination unit adapted to perform at least one of the following: determine, based on the comparison, whether the resource constrained environment has sufficient resources for a predetermined scenario; and determine, based on the comparison, whether to adjust at least one of staffing or equipment or consumable infrastructure resource use associated with the resource constrained environment.

The resource monitoring system may further comprise a first use value generation unit adapted to: determine a number of times a predetermined task, associated with the facility, is performed during the period of time; obtain an average time value representative of the average period of time required to perform the predetermined task; generate the first use value based on the product of the number of times the task is to be performed and the average time value.

In embodiments, the resource monitoring system further comprises a second use value generation unit adapted to: segment the equipment and infrastructure associated with the resource constrained environment into at least two categories; obtain an average resource consumption value, representative of the average resource consumption over the period of time, for each category; multiply a number of equipment and infrastructure in each category by the average power consumption value associated with the respective category, thereby obtaining at least two multiplied power consumption values; and sum the multiplied power consumption values to obtain the second use value.

These and other aspects of the invention will be apparent from and elucidated with reference to the embodiment(s) described hereinafter.

### BRIEF DESCRIPTION OF THE DRAWINGS

Examples of the invention will now be described in detail with reference to the accompanying drawings, in which:

FIG. 1 is a flowchart illustrating a resource monitoring method according to an embodiment of the invention;

FIG. 2 illustrates a clinical facility in a resource constrained environment;

FIG. 3 is a flowchart illustrating a method of obtaining a first use value;

FIG. 4 is a diagram illustrating an embodiment of the method of obtaining the first use value;

FIG. 5 is a diagram illustrating another method of obtaining the first use value;

FIG. 6 illustrates a resource monitoring system for a facility in a resource constrained environment according to an embodiment of the invention; and

FIG. 7 illustrates a computer for performing a resource monitoring method according to an embodiment of the invention.

### DETAILED DESCRIPTION OF THE EMBODIMENTS

The invention provides a resource monitoring method for a facility in a resource constrained environment, the method being adapted to provide a facility rating value based on measures of both human resource consumption and equipment or infrastructure resource consumption over a period of time. A first use value is obtained, representative of a measure of human resource used over a period of time. A second use value is obtained, representative of a measure of resource consumption of equipment and infrastructure (i.e. non-human resource use) over the same period of time. The facility rating value is generated based on the first use value and the second use value.

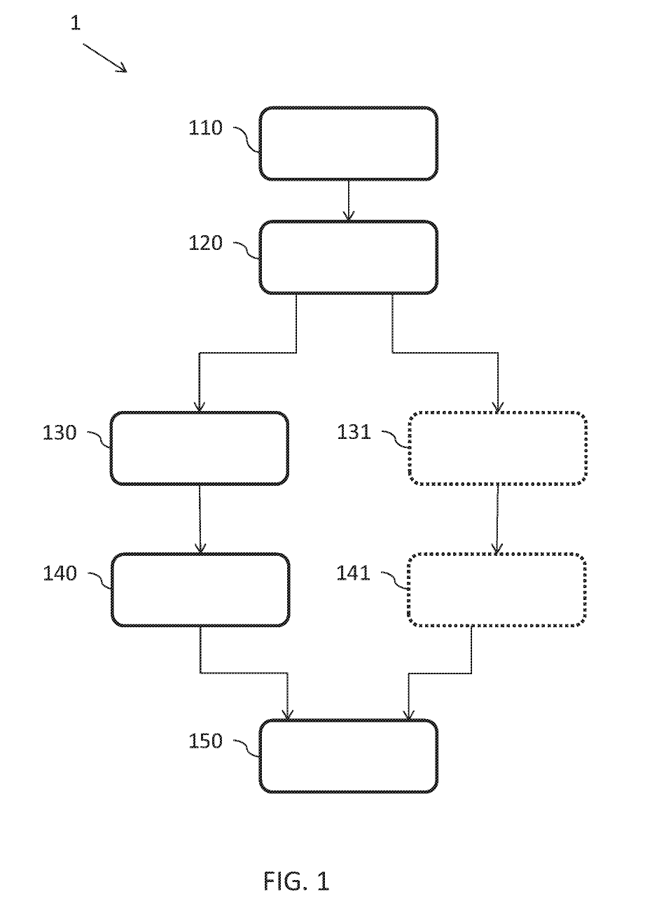

With reference now to FIG. 1, a resource monitoring method 1 for a facility in a resource constrained environment will be described. The method comprises obtaining 110 a first use value, the first use value being representative of an expenditure or amount of human resource used over a predetermined period of time. The method also comprises obtaining 120 a second use value, the second use value being representative of a resource consumption of equipment or infrastructure during the same predetermined period of time.

Thus a first use value is generated or obtained, representative of a human or labour resource expended over a predetermined period of time. Such an indicator may represent a number of working hours, an amount of knowledge, a capability of staff, a staffing level or even an amount of energy expended by staff.

Similarly, a second use value is generated or obtained, representative of an amount of resource consumed or used by equipment or infrastructure of the facility. Such a second use value may represent, for example, any combination of one or more of the following: an amount of electrical energy used, an amount of water used; an amount of gas used; an amount of raw materials used; an amount of oil used; an amount of coal used; and so on. In other words, the second use value may represent an amount of non-human resource consumption. In particular facilities, for example, a clinical facility in a resource constrained environment, the second use value may represent an amount of (a particular) medicine, an amount of reagent (for laboratory testing) or even an amount of disposable materials, such as gloves, syringes, bandages or other medical supplies. It will therefore be apparent that the second use value or the measure of non-human resource (i.e. the equipment or infrastructure resource) may depend upon the facility or the setting in which the facility is.

Typically, at least one of the first use value and the second use value is representative of the resource which is constrained with respect to the resource constrained environment.

The predetermined period of time is a period of time over which the human resource consumption and the equipment/infrastructure resource consumption is measured. By way of example, the predetermined period of time may be a 24-hour period of time (e.g. a day). Preferably, the period of time is greater than one hour, for example, greater than two hours, for example, greater than eight hours.

The method 1 also comprises generating 130 a facility rating value based on the first use value and the second use value.

The facility rating value may be calculated by performing an operation using the first use value and the second use value. By way of example, a composite facility rating may be calculated 130 by summing the first use value and the second use value. In another example, a ratio facility rating value is calculated 131 by dividing the first use value by the second use value (or vice versa).

Generation of the facility rating value allows for the resources (both human and non-human) of the facility to be readily and intuitively monitored.

In embodiments, the method comprises comparing 140 the facility rating value to a reference rating value. A determination may be made, for example, as to whether or not the facility rating value is greater than, equal to, or less than the reference rating value.

In some further embodiments, based on the comparison, the method comprises either determining 150 an action to be performed or whether the facility has sufficient resource for a predetermined scenario or both.

In other words, the method may comprise determining 150 whether to change at least one of a staffing level (i.e. a human resource), an equipment use (i.e. how much resource is used by equipment) or an infrastructure use (i.e. how much resource is used by infrastructure).

In at least one embodiment, the method comprises generating 130 a composite facility rating value and generating 131 a ratio facility rating value. Such a method may comprise comparing 140 the composite facility rating value to a composite reference rating value and comparing 141 the ratio facility rating value to a ratio reference rating value. The determining 150 may be based on the result of both such comparisons.

The facility rating value(s) is indicative of a total resource capability of the facility. The facility rating value takes into account both a labour or human resource (e.g. staffing ability) and a resource used by equipment/infrastructure (e.g. water, electricity, oil, gas, raw materials etc.). Provision of a single facility rating value allows for an intuitive and easy indication of a total resource capability to be observed, monitored and compared.

In preferable embodiments, the facility rating value is compared to a reference rating value. The reference rating value may be indicative of an ideal or desired rating value (i.e. a rating value which the facility is targeting). The reference rating value may be obtained, for example, from a similar facility in a similar resource constrained environment. In other embodiments, the reference rating value represents a predetermined scenario (e.g. a desired scenario) allowing the method to determine whether appropriate resources can be provided in a predetermined scenario.

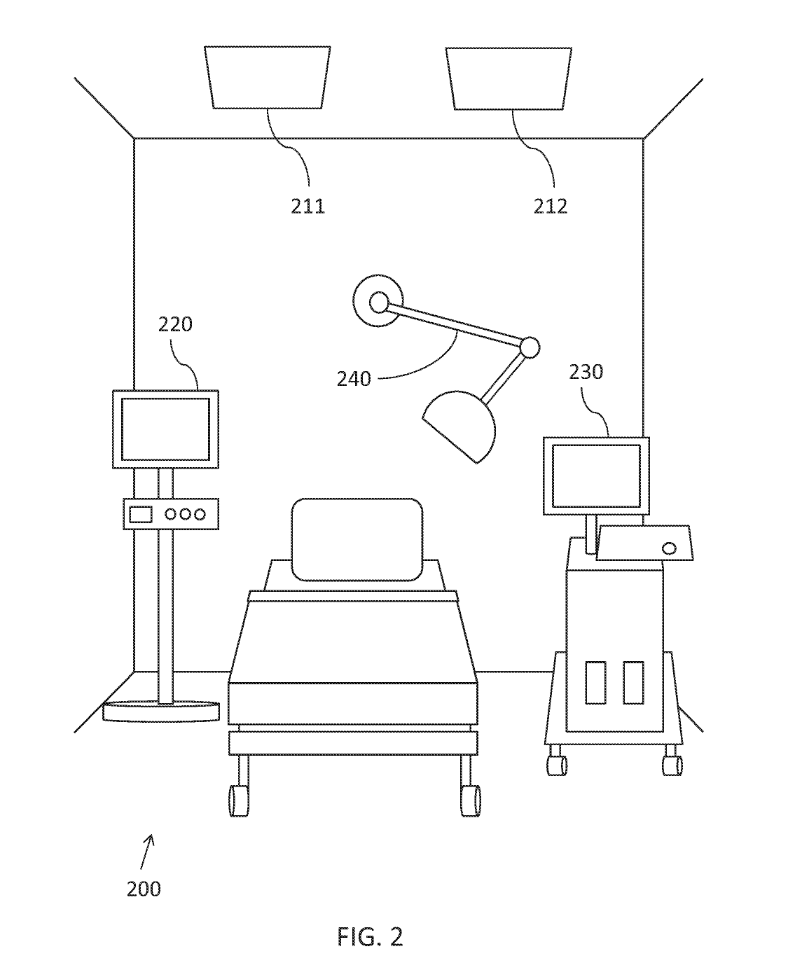

To further explain the concept of equipment and infrastructure, reference is made to FIG. 2, which shows a clinical facility 200 in a resource constrained environment. Identifiable in the clinical facility 200 is a first lighting arrangement 211 and a second lighting arrangement 212, a patient monitoring system 220, a medical ultrasound scanner 230 and a medical lighting arrangement 240 (e.g. a surgical light).

Each of these pieces of equipment may use a resource (e.g. electricity) to undertake their role. The resource they used may have limited availability, due to the resource constrained environment (e.g. minimal or little access to electricity). Whilst embodied pieces of equipment all use electricity as a resource, it will be apparent that other equipment/infrastructure items may use an alternative resource (e.g. a gas or propane fridge or a water-based shower or toilet).

The first lighting arrangement 211 and the second lighting arrangement 212 may be attributable to ‘infrastructure’ (i.e. as they are immovable objects typically integral to the building).

The patient monitoring system 220 and the medical ultrasound scanner 230 may be categorised as ‘equipment’, as they are typically movable and do not form part of the building. They also have a necessary medical purpose or role to carry out.

The medical lighting arrangement 240 may be categorised as either infrastructure (as it is typically immovable) or as equipment (as it provides a necessary medical role—provision of directed light for surgery etc.). It may be understood that, depending upon the use, the medical lighting arrangement may be assigned into either the infrastructure of the equipment category.

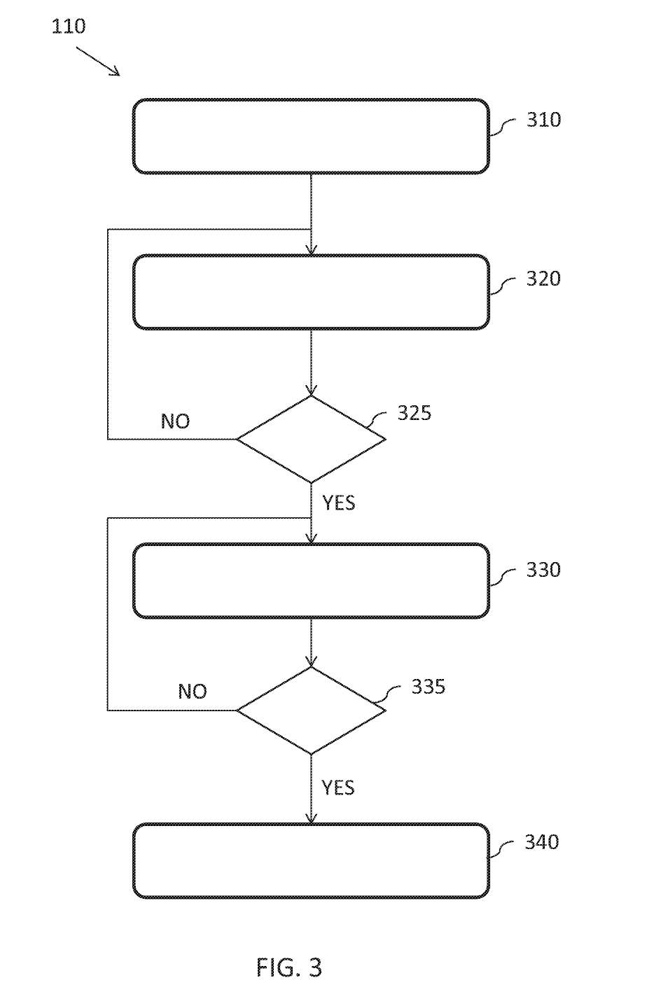

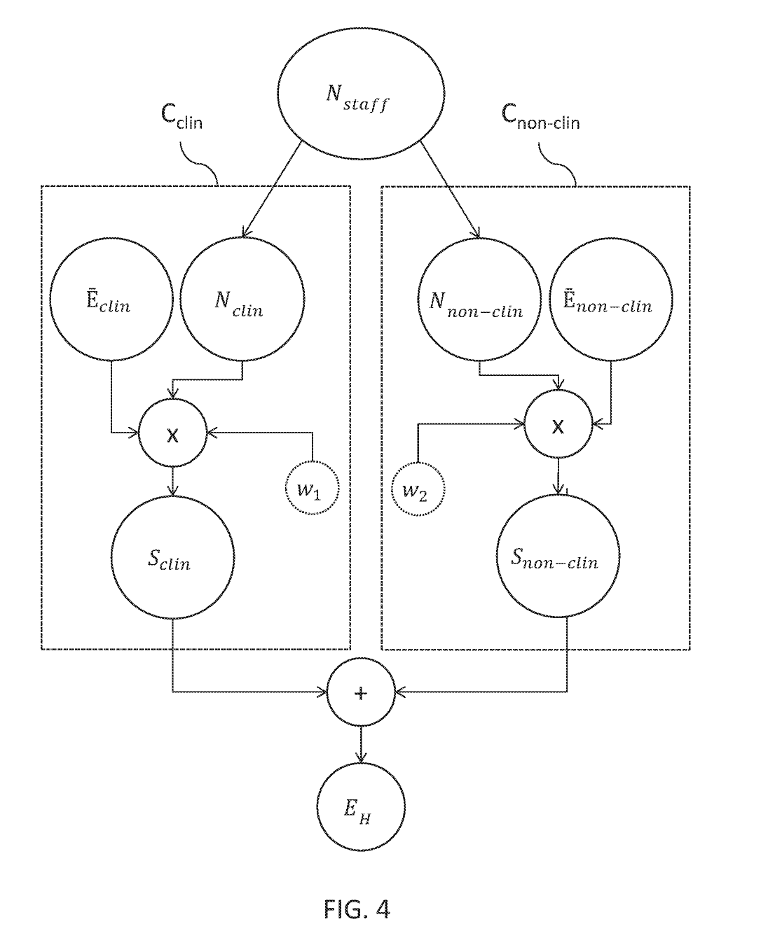

With reference to FIGS. 3 and 4, a method of obtaining 110 the first use value may be explained. FIG. 3 illustrates a flow chart of performing the method 110, and FIG. 4 illustrates an exemplary scenario of performing the method 110.

The method 110 comprises segmenting 310 staff associated with the facility into at least two categories, and obtaining 320, 325 (for each category) an average expenditure value representative of an average expenditure of human energy for a member of staff in that category.

The segmentation 310 may comprise, for each member of staff associated with the facility and active over the period of time, assigning the member of staff into a category, and determining, for each category, a number of members of staff in that category. In some embodiments, the segmentation comprises, for each category, determining a number of staff (active during the period of time) that fall within that category.

In other or further embodiments, the segmentation 310 comprises determining a total number of working hours performed by members of staff in each category. Such embodiments may comprise obtaining a total number of hours worked over the period of time, and segmenting or portioning the total number of hours into at least two categories. Other embodiments may include obtaining a number of staff in each category, and multiplying by an average number of hours worked for a member of staff in that category.

The step of obtaining the average expenditure value 320, 325 may comprise obtaining 320 an average expenditure value for a category and determining 325 if an average expenditure value has been obtained for each category. If an average expenditure value has not been obtained for each category, an average expenditure value (for the next category) is obtained.

The average expenditure value may be representative of an average amount of energy expended by a member of staff in that category during the time period. Such an average amount may, for example, be a historic or recommended amount of energy expended, such as calories used, during the time period. In other embodiments, the average expenditure value is an average number of man-hours performed by a member of staff in that category or a measure of efficiency of staff in that category. This average value may, for example, be a historic or recommended number of man-hours.

If/when an average expenditure value has been obtained for each category, a human resource added is calculated 330, 335 for each category. This may be performed by multiplying the total number of staff or staffing hours in the category by the average expenditure value associated with that category.

The calculation 330, 335 may be performed by calculating 330 a human resource addend for a category and determining 335 whether a human resource addend has been obtained for each category. If a human resource addend has not been calculated for each category, a human resource addend (for the next category) is calculated.

To obtain 340 the first use value, all human resource addends are summed. In conceivable other embodiments, all human resource addends may alternatively be multiplied or otherwise operated on.

One particular embodiment of this method may be conceptually understood with reference to FIG. 4, which illustrates an obtaining of a first use value for a facility in a clinical resource constrained environment. There is first identified a number of staff or total staffing hours N_{staff} available over the period of time at the facility. The number of staff or total staffing hours is divided into a first C_{clin} and a second category G_{non-clin}, associated with clinical staff and non-clinical staff respectively. Thus, there is obtained a number of clinical staff (or staffing hours) N_{clin} and a number of non-clinical staff (or staffing hours) N_{non-clin}.

In other words, respective numbers of clinical N_{clin} and non-clinical staff N_{non-clin} or staffing hours are identified.

Each category C_{clin}, C_{nonclin} (i.e. each obtained number of staff) is associated with a respective average expenditure of human energy. By way of example, the clinical staff may be associated with an average expenditure of human energy for clinical staff Ē_{clin}, and the non-clinical staff may be associated with an average expenditure of human energy for non-clinical staff Ē_{non-clin}.

The average expenditure of human energy Ē_{clin}, Ē_{non-clin} represents an average energy expenditure over the period of time, and may represent a number of staffing hours, an amount of energy (e.g. calories) expended by the staff and the like.

By way of example, the average expenditure of human energy may be representative of a daily energy consumption of staff (in a particular category).

For each category C_{clin}, C_{non-clin}, a respective human resource addend is obtained by multiplying the number of staff (in the category) by the average expenditure of human energy (of the category). By way of example, the number of clinical staff N_{clin} is multiplied by the average expenditure of human energy of clinical staff Ē_{clin} so as to obtain the clinical staff human resource addend S_{clin}.

To obtain the first use value E_{H}, the human resource addends S_{clin}, S_{non-clin} from each category are summed. It will therefore be apparent that the obtaining of the first use value may be obtained using the following equation:

E_{H}=ΣĒ_{clin}·N_{clin}+ΣĒ_{non-clin}·N_{non-clin} (1)

In some embodiments, there is provided a weighting factor w₁, w₂ for each category C_{clin}, C_{non-clin}. The weighting factor may, for example, represent a relative importance, relevancy or efficiency of (members of staff of) a particular category. By way of example, for a clinical environment, human resource associated with clinical staff may be considered to be more efficient or relevant to determining a facility rating value than human resource associated with non-clinical staff.

It will be apparent that the average expenditure of human energy may be an estimate based on historic or known value, for example, values associated with a different facility.

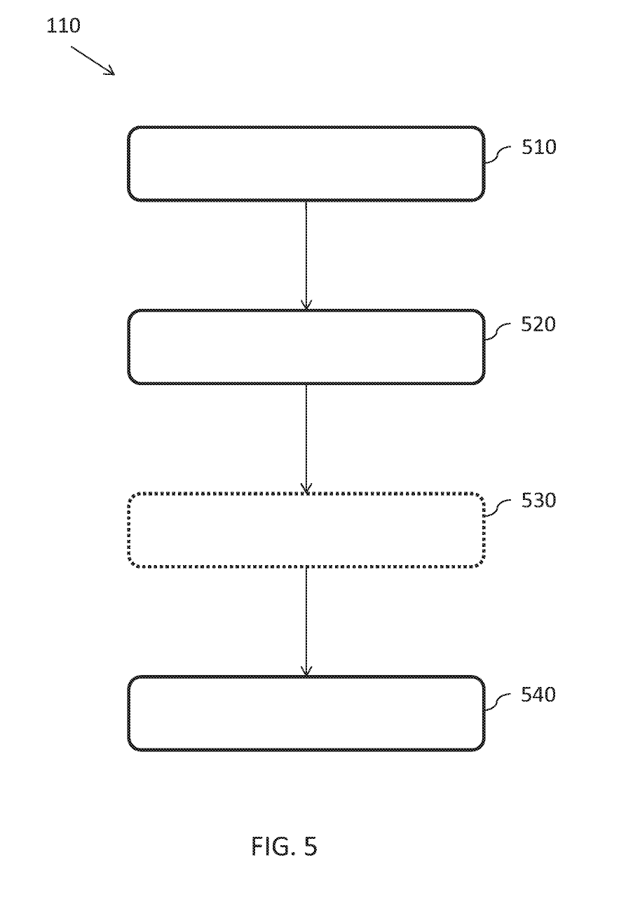

A second embodiment of obtaining the first use value may be described with reference to FIG. 5, which illustrates a flow chart of a method of obtaining the first use value.

The method comprises determining 510 a number of times Nₜₐₛₖ a predetermined task is performed over the predetermined period of time.

The method further comprises determining 520 an average time period Tₜₐₛₖ spent performing the task. In other words, the average time period Tₜₐₛₖ represents the mean, modal or median amount of time that a member of staff, capable of performing the task, requires to perform or undertake the task.

By way of example, the predetermined task may be (for a clinical environment) a physician-patient consultation. The number of times Nₜₐₛₖ the predetermined task is to be performed may represent a number of physician-patient consultations performed during the predetermined time period. The average time period Tₜₐₛₖ may represent an average length of a physician-patient consultation period.

The first use value E_{H} may then be 540 obtained based on the number of times Nₜₐₛₖ a predetermined task is performed and the average time period Tₜₐₛₖ spent performing the task. By way of example, the first use value may be obtained by multiplying the number of times Nₜₐₛₖ the predetermined task is performed by the average time period Tₜₐₛₖ spent performing the task.

Thus, in some embodiments, the first use value may be obtained according to the following equation:

E_{H}=Tₜₐₛₖ·Nₜₐₛₖ (2)

In some embodiments, the first use value is obtained further based on an average energy expenditure Eₜₐₛₖ during the task.

E_{H}=Ēₜₐₛₖ·Tₜₐₛₖ·Nₜₐₛₖ (3)

By way of example, the average time period spent performing the task may be measured in minutes or seconds. The average energy expenditure spent performing the task may be measured in average calories expended per minute or average calories expended per second, or possibly average kJ of energy expended per minute or average kJ of energy expended per second.

In an alternative embodiment, the step of determining 510 a number of times Nₜₐₛₖ a predetermined task is to be performed may instead be a step of determining a number of staff capable of performing the predetermined task. Similarly, the step of obtaining 520 an average time period may instead be a step of obtaining an average amount of time spent by staff performing the task over the period of time, such that the first use value represents a number of staff capable of performing the task multiplied by an total average amount of time spent performing the task.

In conceivable embodiments, the first use value is obtained using a combination of above-described methods. For example, a first human resource addend may be obtained using the method described with reference to FIG. 5 (Tₜₐₛₖ·Nₜₐₛₖ) and a second human resource addend may be obtained using the method described with reference to FIG. 3 (E_{non-clin}·N_{non-clin}).

The second use value (Ē_{NH}) may be obtained in a similar manner to the method of obtaining the first use value as described with reference to FIG. 3. Reference shall therefore be made to the flowchart of FIG. 3 in described the obtaining of the second use value.

That is to say, the second use value may be obtained by segmenting 310 the equipment and infrastructure into at least two categories, obtaining 320, 325 an average resource consumption value for each category, generating 330, 335 a respective resource consumption addend for each category, and summing 340 each respective resource consumption addend.

By way of example, for a clinical facility in a resource constrained environment, the equipment and infrastructure may be segmented into a medical equipment category, a non-medical equipment category and an infrastructure category. A number of pieces of equipment in each category is obtained.

Put another way, a number of pieces of medical equipment N_{medeq}, of non-medical equipment N_{nonmedeq}, and of infrastructure N_{infra} may be respectively obtained.

For each of these categories, a respective average resource consumption value is obtained. By way of example, an average resource consumption value for medical equipment Ē_{medeq}, an average resource consumption value for non-medical equipment Ē_{nonmedeq}, and an average resource consumption value for infrastructure equipment (Ē_{infra}) may be obtained.

The average resource consumption value is representative of the average amount of resources (e.g. amount of electricity, volume of water, volume of gas, etc.) used by the elements in the category over the predetermined period of time. By way of example, if we consider the medical equipment category, the average resource consumption value E_{medeq} may be representative of an average amount of energy expended over a day by a piece of medical equipment (e.g. a medical ultrasound machine).

It will be clear that the second use value may be obtained using the following equation:

E_{NH}=F_{S}(Σ(Ē_{med eq}·N_{med eq})+Σ(Ē_{nonmed eq}·N_{nonmed eq})+Σ(Ē_{infra}·N_{infra})) (4)

The facility rating value is obtained using both the first use value and the second use value. By way of example, a composite facility rating value (E_{composoite}) may be obtained by summing the first use value and the second use value (E_{H}+E_{NH}). A ratio facility rating value (R) may be obtained by dividing the first use value by the second use value (E_{H}/E_{NH}) or vice versa (E_{NH}/E_{H}). Other possible method of obtaining a facility rating value (such as subtraction, multiplication and so on) will be readily apparent to the person skilled in the art.

In some preferable embodiments, more than one facility rating value is obtained, for example, both a composite facility rating value and a ratio facility rating value may be obtained.

In preferable embodiments, the facility rating value is compared to a reference rating value. In this way, a determination of whether the facility has suitable resources (both human and for equipment/infrastructure) may be determined by comparing to a reference rating value associated with a known, desired or preferred resource use.

The reference rating value may, in some embodiments, be a predetermined threshold. However, in preferable embodiments, the reference rating value represents a desired or optimal rating value for an identical or similar facility in an identical or similar resource constrained environment. In this way, a determination of whether the facility is meeting a desired or optimal resource usage may be readily and intuitively measured, in a quantitative and objective manner.

By way of example, for a clinical or healthcare facility (Facility A) in a resource constrained environment, the facility rating value may be compared to a reference rating value obtained from another existing healthcare facility (of comparable size and with similar characteristics) in which it is known that a high quality of care is maintained (Facility B). In this way, a determination of whether Facility A is providing a suitable high quality of care may be performed.

In particular, Facility A may be associated with a composite facility rating value E_{composite} and a ratio facility rating value R, and Facility B may be associated with a composite reference rating value E_{reference} and a ratio reference rating value R_{reference}. A comparison may be made between the respective rating values, and a determination of the current operation of Facilty A may be performed as follows:

TABLE 1

| E_{composite} | | R | | Determination of operation of Facility A |
|---|---|---|---|---|
| >= | E_{reference} | >= | R_{reference} | Sufficient Resources |
| | | | | Likely Overstaffed |
| < | E_{reference} | >= | R_{reference} | Insufficient Resources, |
| | | | | Likely Insufficient Resources for |
| | | | | Equipment/Infrastructure |
| >= | E_{reference} | < | R_{reference} | Sufficient Resources, |
| | | | | Likely Excess Resources for Equipment |
| | | | | or Infrastructure |
| < | E_{reference} | < | R_{reference} | Insufficient Resources |
| | | | | Likely Understaffed |

Such an embodiment allows a method of monitoring whether a facility in a resource constrained environment is sufficiently resourced, both in terms of human resources and with respect to resources for equipment or infrastructure. The determination of operation of Facility A may be provided to a user, for example, using a visual display device such as a screen.

To provide additional detail or granularity, it is conceivable that the method may obtain or derive other parameters based on the facility rating value (or the first/second use value). For example, this may include finding the ratio of the first use value or the second use value to catchment population size—or finding the ratio of the first use value or the second use value to the number of similar facilities in the vicinity.

Furthermore, it is conceivable that comparison or rating values may be determined based on a select number (i.e. a selected one or more) of categories associated with at least the equipment/infrastructure of the facility. This may allow for a breakdown of resource usage, and allows for the ability to identify the most critical energy consumption services or equipment, or those which are using excess or substantial amounts of resource.

In some embodiments, based on the comparison between the facility rating value and the reference rating value, the method may comprise determining an action to be performed. Such an action may be performed in an attempt to improve or optimize the resource usage of the facility. Put another way, the action may be one of changing a resource management scheme of the facility, so as to change the way in which at least one resource is managed, used, assigned or controlled.

By way of example, the method could determine to increase a staffing level (if it is determined that the facility is understaffed) or reduce a staffing level (if it is determined the facility is overstaffed). In some embodiments, the method may determine to reassign staff to other roles (e.g. reassign clinical staff into non-clinical roles). It is apparent that such actions would adjust an amount of human resources associated with the facility.

In other examples, the method could determine to apply or change resource conservation practices of the equipment and infrastructure. By way of example, the method may recommend the use of energy saving devices, or instituting procedures to reduce energy or water wastage.

In yet other examples, the method could determine to change equipment utilization, for example, in an attempt to reduce idle time of one or more pieces of equipment. This would improve an efficiency of resource consumption associated with equipment, as they could be more effectively deployed.

In some embodiments, the method may determine to adjust resource generation and storage capacities. By way of example, the method may determine that more electricity needs to be generated, or additional water resources need to be acquired and so on. Optionally, the method may determine to adjust a parameter of resource generating equipment (e.g. a tilt angle of solar panels, a battery size of an electrical generator and so on).

Optionally, the method may comprise determining to reschedule staff and equipment use, by, for example, changing staffing hours for a member of staff to minimise an amount of human resource expended by staff. In some embodiments, the method may schedule tasks (using specific pieces of equipment) to only be performed on particular days. This would ensure that such equipment is more efficiently utilized (i.e. as more tasks are likely to be performed over a day), rather than intermittently idling during the day.

In further embodiments, the method may comprise to reassign tasks (e.g. patient consultations) to other, preferably nearby, facilities. This will reduce a burden on both the human resource and the resources used by equipment/infrastructure.

It will be apparent that successive iterations of determining the facility rating value and determining to perform an action based on a comparison between the facility rating value and a reference rating value may be performed. That is to say, based on the facility rating value, a resource deployment may be adjusted and the facility rating value may be re-obtained to determine if the change in resource deployment has improved (or unimproved) the facility rating value.

The facility rating value may also be used to compare or evaluate similar facilities. This may be of particular use in the healthcare or educational sectors, to assess the performance of facilities, plan for the future and to help determine efficiency in allocation of resources.

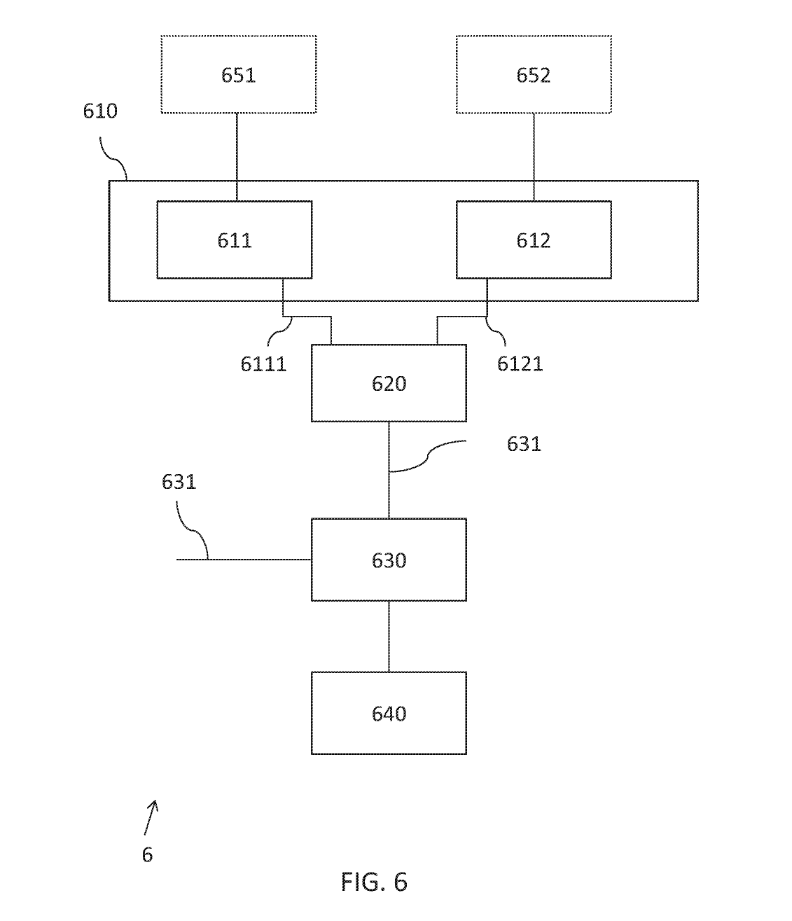

With reference now to FIG. 6, a resource monitoring system 6 for a facility in a resource constrained environment according to an embodiment may be described.

The resource monitoring system comprises an obtaining unit 610 comprising a first use value obtaining unit 611, which is adapted to obtain a first use value 6111, and a second use value obtaining unit 612, which is adapted to obtain a second use value 6121.

The resource monitoring system also comprises a generation or calculation unit 620 adapted to generate a facility rating value 631 based on the first use value 6111 and the second use value 6121 (obtained by the first use value obtaining unit 611 and the second use value obtaining unit 612 respectively).

In some embodiments, the resource monitoring system comprises a comparison unit 630 adapted to compare the facility rating value to a reference rating value 631.

In some further embodiments, the resource monitoring system comprises a determination unit 640 adapted to determine an action to be performed based on the comparison.

In optional embodiments, the first use value may be obtained based on a signal received from a human resource measurement arrangement 651, and the second use value may be obtained based on a signal obtained from an equipment and infrastructure measurement arrangement 652.

In some embodiments, the first use value obtaining unit 611 is a first use value generation unit adapted to generate a first use value, using a method as previously described. In some further or other embodiments, the second use value obtaining unit 612 is a second use value generation unit adapted to generate a second use value, using a method as previously described.

As used herein, human resource should be understood to refer to the available man-hours or available work output by staff members or employees (or even volunteers) during the period of time. By way of example, if a particular facility hires only a single member of staff, working a full 8 hour day, the human resource expended in a 24-hour period may be a maximum of 8 man-hours. Human resource may otherwise refer to the available number of staff during the predetermined time period.

In some embodiments, the first use value, representing the human resource expenditure, may be representative of a measure of the energy expended by staff in performing their roles. By way of example, a total calorific energy expenditure of a single human resource (i.e. an employee) may be estimated or measured by counting a number of steps an average member of staff takes. In another example, a system or method may include monitoring a calorific intake of members of staff to estimate or measure a calorific energy expenditure of a member of staff. In yet other embodiments, it may be measured using wearable or portable devices such as smart watches, smart phones, fitness trackers and so on.

The second use values, representing resource consumption of the equipment and infrastructure, may comprise a measure of how much a restricted resource is used within the predetermined period of time. By way of example, if the constrained resource is electrical power, energy meters may be used to determine a difference in cumulative electrical power at a start of the period of time, and at an end of the period of time. If the constrained resource is water, a water meter may be used to determine an amount of water resource used. In the event the constrained resource is raw materials for a factory, an amount of processed material during the period of time may be representative of the resource consumed during the period of time.

Other measures of resource consumption will be readily contemplated and apparent to the person skilled in the art.

Although reference is made throughout the description to clinical or healthcare facilities in a resource constrained environment, it is apparent the proposed method may be used for any facility in a resource constrained environment. By way of example, the method may also be particularly advantageous for an educational facility.

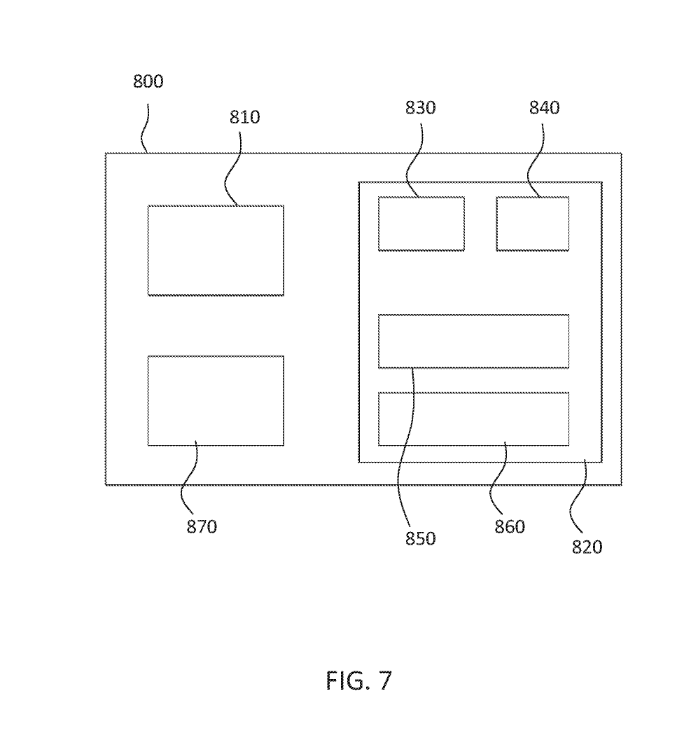

FIG. 7 illustrates an example of a computer 800 within which one or more parts of an embodiment may be employed. Various operations discussed above may utilize the capabilities of the computer 800. For example, one or more parts of a resource monitoring system may be incorporated in any element, module, application, and/or component discussed herein.

The computer 800 includes, but is not limited to, PCs, workstations, laptops, PDAs, palm devices, servers, storages, and the like. Generally, in terms of hardware architecture, the computer 800 may include one or more processors 810, memory 820, and one or more I/O devices 870 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 810 is a hardware device for executing software that can be stored in the memory 820. The processor 810 can be virtually any custom made or commercially available processor, a central processing unit (CPU), a digital signal processor (DSP), or an auxiliary processor among several processors associated with the computer 800, and the processor 810 may be a semiconductor based microprocessor (in the form of a microchip) or a microprocessor.

The memory 820 can include any one or combination of volatile memory elements (e.g., random access memory (RAM), such as dynamic random access memory (DRAM), static random access memory (SRAM), etc.) and non-volatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 820 may incorporate electronic, magnetic, optical, and/or other types of storage media. Note that the memory 820 can have a distributed architecture, where various components are situated remote from one another, but can be accessed by the processor 810.

The software in the memory 820 may include one or more separate programs, each of which comprises an ordered listing of executable instructions for implementing logical functions. The software in the memory 820 includes a suitable operating system (O/S) 850, compiler 840, source code 830, and one or more applications 860 in accordance with exemplary embodiments. As illustrated, the application 860 comprises numerous functional components for implementing the features and operations of the exemplary embodiments. The application 860 of the computer 800 may represent various applications, computational units, logic, functional units, processes, operations, virtual entities, and/or modules in accordance with exemplary embodiments, but the application 860 is not meant to be a limitation.

The operating system 850 controls the execution of other computer programs, and provides scheduling, input-output control, file and data management, memory management, and communication control and related services. It is contemplated by the inventors that the application 860 for implementing exemplary embodiments may be applicable on all commercially available operating systems.

Application 860 may be a source program, executable program (object code), script, or any other entity comprising a set of instructions to be performed. When a source program, then the program is usually translated via a compiler (such as the compiler 840), assembler, interpreter, or the like, which may or may not be included within the memory 820, so as to operate properly in connection with the O/S 850. Furthermore, the application 860 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, JavaScript, FORTRAN, COBOL, Perl, Java, ADA, .NET, and the like.

The I/O devices 870 may include input devices such as, for example but not limited to, a mouse, keyboard, scanner, microphone, camera, etc. Furthermore, the I/O devices 870 may also include output devices, for example but not limited to a printer, display, etc. Finally, the I/O devices 870 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 870 also include components for communicating over various networks, such as the Internet or intranet.

If the computer 800 is a PC, workstation, intelligent device or the like, the software in the memory 820 may further include a basic input output system (BIOS) (omitted for simplicity). The BIOS is a set of essential software routines that initialize and test hardware at startup, start the O/S 850, and support the transfer of data among the hardware devices. The BIOS is stored in some type of read-only-memory, such as ROM, PROM, EPROM, EEPROM or the like, so that the BIOS can be executed when the computer 800 is activated.

When the computer 800 is in operation, the processor 810 is configured to execute software stored within the memory 820, to communicate data to and from the memory 820, and to generally control operations of the computer 800 pursuant to the software. The application 860 and the O/S 850 are read, in whole or in part, by the processor 810, perhaps buffered within the processor 810, and then executed.

When the application 860 is implemented in software it should be noted that the application 860 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 860 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

Any reference signs in the claims should not be construed as limiting the scope.

1. A resource monitoring method for a facility in a resource constrained environment, the method comprising:
obtaining a first use value representative of an expenditure of human resource associated with the facility over a period of time;
obtaining a second use value representative of a resource consumption of equipment and infrastructure associated with the facility over the same period of time; and
generating a facility rating value based on the first use value and the second use value, the facility rating value thereby providing an indication of human, equipment and infrastructure resources expended over the period of time.

2. The resource monitoring method of claim 1, wherein the generating the facility rating value comprises at least one of the following:
generating a composite facility rating value representative of a sum of the first use value and the second use value; and
generating a ratio facility rating value representative of a ratio of the first use value to the second use value or vice versa.

3. The resource monitoring method of claim 1 further comprising:
comparing the facility rating value to a reference rating value.

4. The resource monitoring method of claim 3, further comprising performing at least one of:
determining, based on the comparison, whether the facility has sufficient resources for a predetermined scenario; and
determining, based on the comparison, whether to adjust at least one of staffing, equipment use or infrastructure use associated with the facility.

5. The resource monitoring method of claim 1, wherein generating the facility rating value comprises:
generating a composite facility rating value representative of a sum of the first use value and the second use value; and
generating a ratio facility rating value representative of a ratio of the first use value to the second use value or vice versa,
and wherein the further method comprises:
comparing the composite facility rating value to a composite reference rating value;
comparing the ratio facility rating value to a ratio reference rating value; and
determining, based on the two comparisons, whether the facility has appropriate resources for a predetermined scenario.

6. The resource monitoring method of claim 1, wherein the obtaining the first use value comprises:
segmenting staff, associated with the facility and available during the period of time, into at least two categories;
obtaining, for each category, an average expenditure value representative of the average expenditure of human resource over the period of time for the respective category;
generating, for each category, a human resource addend, the generating comprising multiplying a number of staff in the respective category by the average expenditure value associated with the respective category; and
summing the human resource addends to obtain the first use value.

7. The resource monitoring method of claim 1, wherein obtaining the first use value comprises:
determining a number of times a predetermined task, associated with the facility, is performed during the period of time;
obtaining an average time value representative of the average period of time required to perform the predetermined task; and
generating the first use value based on the product of the number of times the task is to be performed and the average time value.

8. The resource monitoring method of claim 7, further comprising obtaining an average energy value representing the average energy expended in performing the predetermined task,
wherein the generating of the first use value is further based on the average energy value.

9. The resource monitoring method of claim 1, wherein obtaining the second use value comprises:
segmenting the equipment and infrastructure associated with the facility into at least two categories;
obtaining, for each category, an average resource consumption value representative of the average resource consumption over the period of time for the respective category;
generating, for each category, a resource consumption addend, the generating comprising multiplying a number of equipment and infrastructure in each category by the average resource consumption value associated with the respective category; and
summing the resource consumption addends to obtain the second use value.

10. A clinical environment resource monitoring method comprising the resource monitoring method of claim 1, wherein:
the first use value is representative of the human resource expenditure of at least the clinical staff of a clinical facility over a period of time; and
the second use value is representative of the resource consumption of at least medical equipment of the clinical facility over the same period of time.

11. A resource monitoring system for a facility in a resource constrained environment, the system comprising:
an obtaining unit adapted to obtain a first use value representative of an expenditure of human resource over a period of time and obtain a second use value representative of a resource consumption of equipment and infrastructure of the facility over the same period of time; and
a calculation unit adapted to generate a facility rating value based on the first use value and the second use value.

12. The resource monitoring system of claim 11, further comprising a comparison unit adapted to compare the facility rating value to a reference resource rating.

13. The resource monitoring system of claim 12, further comprising a determination unit adapted to perform at least one of the following:
determining, based on the comparison, whether the facility has sufficient resources for a predetermined scenario; and
determining, based on the comparison, whether to adjust at least one of staffing or equipment use associated with the facility.

14. The resource monitoring system of claim 11, further comprising a first use value generation unit adapted to:
determine a number of times a predetermined task, associated with the facility, is performed during the period of time;
obtain an average time value representative of the average period of time required to perform the predetermined task; and
generate the first use value based on the product of the number of times the task is to be performed and the average time value.

15. The resource monitoring system of claim 11, further comprising a second use value generation unit adapted to:
segment the equipment and infrastructure associated with the facility into at least two categories;
obtain an average power consumption value, representative of the average power consumption over the period of time, for each category;
multiply a number of equipment and infrastructure in each category by the average power consumption value associated with the respective category, thereby obtaining at least two multiplied power consumption values; and
sum the multiplied power consumption values to obtain the second use value.
